(19) United States
(12) Patent Application Publication
(10) Pub. No.: US 2011/0080063 A1
(43) Pub. Date: Apr. 7, 2011

(54) DIRECT-DRIVE MOTOR MODULE

(76) Inventor: Ming-Hung HSIEH, Taichung City (TW)

(21) Appl. No.: 12/574,260

(22) Filed: Oct. 6, 2009

(51) Int. Cl. H02K 7/10

(52) U.S. Cl. 310/77

(57) ABSTRACT

A direct-drive motor module employing a torque motor as a power source. The direct-drive motor module includes a transmission member having the form of a ring-shaped disc with larger radius for transmitting power. The transmission member is directly coupled with an end of the power output shaft of the torque motor, whereby the power output by the torque motor is transmitted to the transmission member to directly drive a load in a rotational manner with larger radius of gyration. Accordingly, the direct-drive motor module can directly drive the load without any reducing mechanism. In this case, the precision of positioning will not be affected due to the backlash of the gears of the reducing mechanism. Also, the number of the components of the motor module is reduced to minify the volume and save room as well as lower energy loss. In addition, the service of the motor module is facilitated.

### BACKGROUND OF THE INVENTION

The present invention relates generally to a driving technique, and more particularly to a direct-drive motor module.

Various conventional motors are used in different fields as power sources. For example, motors are applied to a passenger/goods elevator for driving the same. The transmission mechanisms of the conventional motors, such as linear motors, can be divided into worm type, oil-cylinder type and steel-cable type. In these transmission mechanisms, the steel-cable type transmission mechanism is the most widely used one. FIG. 1 shows a conventional elevator drive module 1 including an induction motor 2 as the power source and a reducing gear box 3 in which numerous reducing gears with different gear ratios or similar components are arranged. The power of the motor 2 is transmitted to a steel cable reel 4 to rotate the same via the reducing gears, which reduce the rotational speed of the power source. Accordingly, a steel cable 5 is wound or unwound to ascend or descend an elevator cabin hung thereon.

In the prior art, the induction motor serves as the power source. The induction motor must output power at higher rotational speed to supply necessary torque for driving the elevator cabin. In the meanwhile, it is necessary to keep the elevator cabin ascending/descending smoothly. Therefore, the reducing mechanism plays an important role in driving the elevator. With the output torque remaining sufficient, the rotational speed is reduced to meet the use requirements of the elevator cabin. However, the reducing mechanism includes numerous components that lead to huge volume of the whole transmission mechanism and increment of service cost. Moreover, the numerous gears are engaged with each other for transmitting the power. This will inevitably affect the precision of positioning due to backlash of the gears and result in power loss. Therefore, the energy can be hardly fully utilized and the elevator cabin cannot be precisely positioned. As a result, when the elevator cabin arrives a certain floor and the doors open, the elevator cabin may be misaligned from the floor. Therefore, the conventional technique has many shortcomings that need to overcome.

### SUMMARY OF THE INVENTION

It is therefore a primary object of the present invention to provide a direct-drive motor module employing a torque motor as a power source. The direct-drive motor module includes a transmission member having the form of a ring-shaped disc with larger radius for transmitting power. The transmission member is directly coupled with an end of the power output shaft of the torque motor, whereby the power output by the torque motor is transmitted to the transmission member to directly drive a load in a rotational manner with larger radius of gyration. Accordingly, the direct-drive motor module can directly drive the load without any reducing mechanism. In this case, the precision of positioning will not be affected due to the backlash of the gears of the reducing mechanism. Also, the number of the components of the motor module is reduced to minify the volume and save room as well as lower energy loss. In addition, the service of the motor module is facilitated.

To achieve the above and other objects, the direct-drive motor module of the present invention includes: a housing having two open ends; two end pieces respectively fixedly disposed on end faces of the open ends of the housing, each end piece having a protruding side, the protruding sides of the end pieces protruding from the same side of the housing by a predetermined length; a ring-shaped outer stator fixedly disposed in the housing; a shaft-shaped inner rotor coaxially rotatably fitted in the outer stator, the inner rotor having a shaft body bridged between the two end pieces, at least one axial end of the shaft body outward protruding from the end piece; a transmission member having a circular body section coaxially fixedly connected with an axial end of the shaft body, whereby the shaft body can drive the transmission member to synchronously rotate with the shaft body, a transmission section being annularly disposed on a circumference of the body section; a brake member for providing brake effect for rotational motion of the inner rotor; and a sensing read head for sensing data of the rotational motion of the inner rotor.

The present invention can be best understood through the following description and accompanying drawings wherein:

### BRIEF DESCRIPTION OF THE DRAWINGS

FIG. 1 is a perspective view of a conventional elevator drive module;

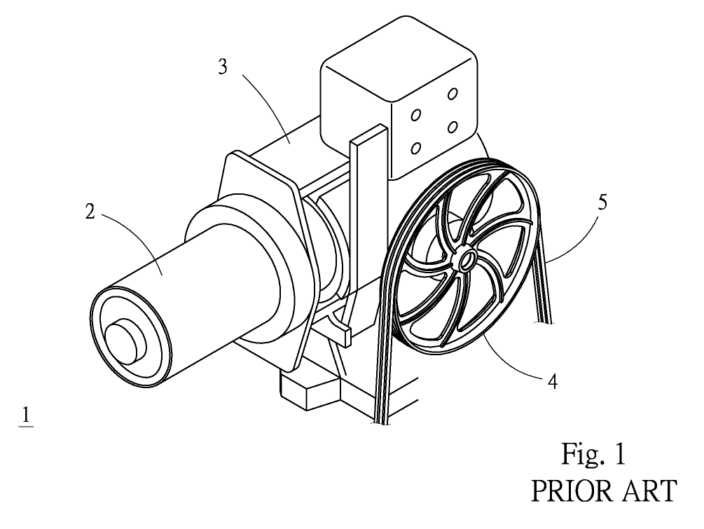

FIG. 2 is a perspective assembled view of a preferred embodiment of the present invention;

FIG. 3 is a perspective schematic exploded view of the preferred embodiment of the present invention;

FIG. 4 is a sectional view of the preferred embodiment of the present invention; and

FIG. 5 is a perspective view showing the application of the present invention.

### DETAILED DESCRIPTION OF THE PREFERRED EMBODIMENTS

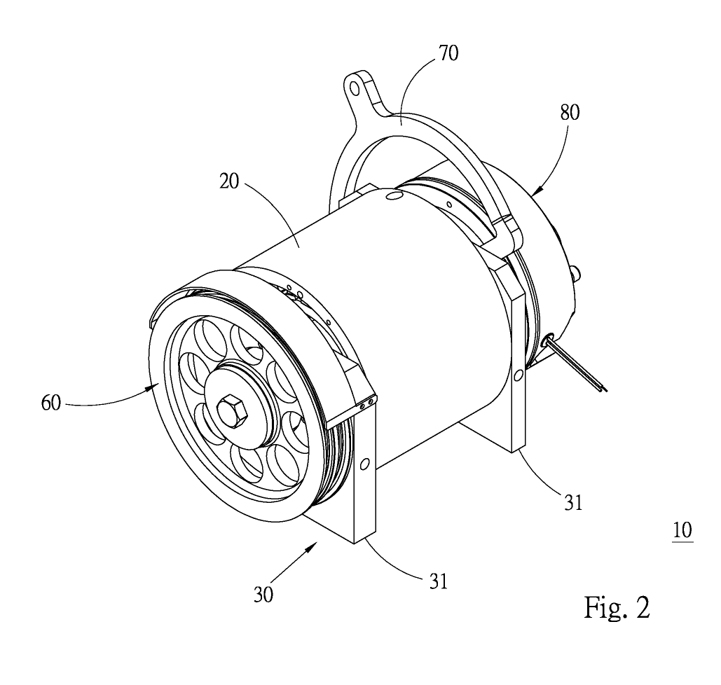

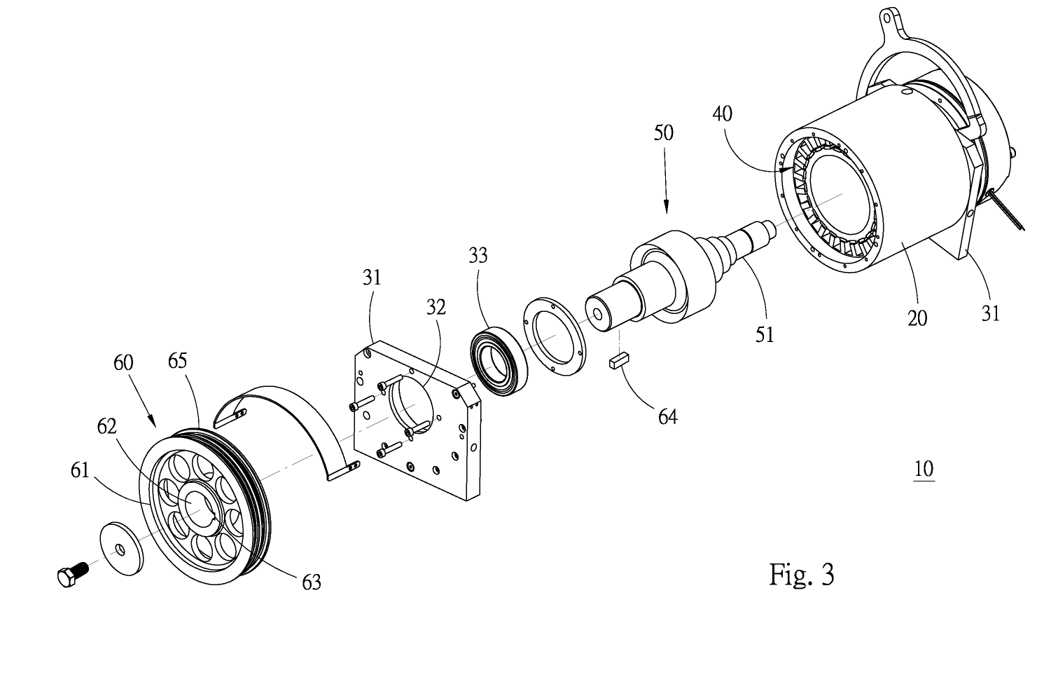

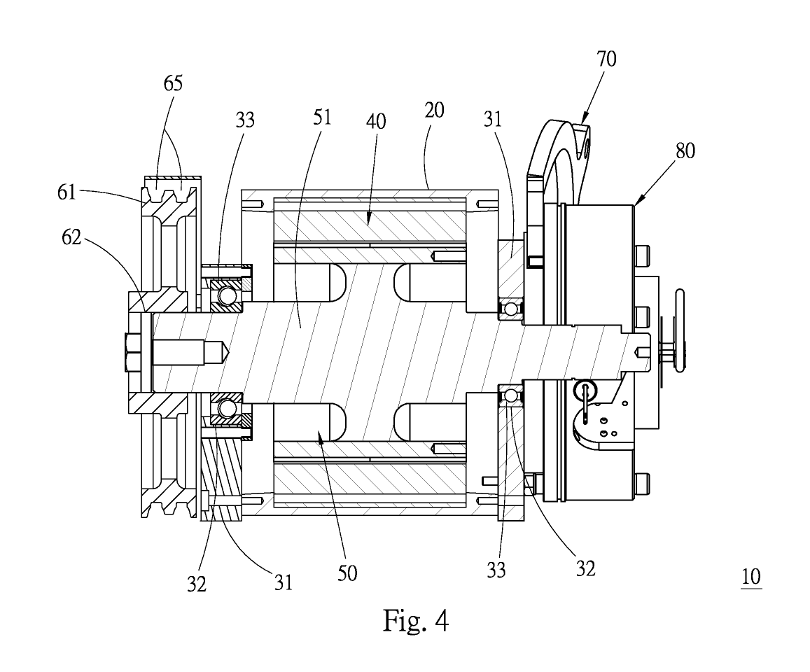

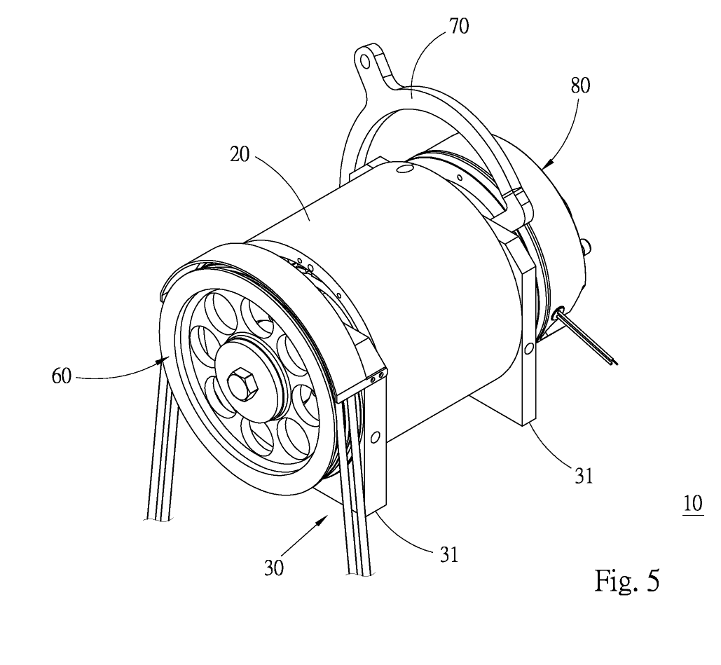

Please refer to FIGS. 2 to 5. According to a preferred embodiment, the direct-drive motor module 10 of the present invention includes a housing 20, two end pieces 30, an outer stator 40, an inner rotor 50, a transmission member 60, a brake member 70 and a sensing read head 80.

The housing 20 is a substantially straight tubular body having two axial open ends.

Each end piece 30 has a plate-shaped end section 31. One face of the end section 31 is fixedly attached to the end face of the open end of the housing 20. One side of the end section 31 protrudes from one side of the housing 20 by a certain length. The edges of the protruding sides of the end sections 31 are straight and positioned on the same plane in parallel to each other. Each end section 31 is formed with a bearing through hole 32 and coaxial with the housing 20. A bearing 33 is coaxially inlaid in the bearing through hole 32.

The outer stator 40 and the inner rotor 50 are well known components of a conventional motor. The inner rotor 50 is driven and rotated under the effect of the electromagnetic field. This pertains to prior art and will not be specifically described hereinafter. The outer stator 40 is ring-shaped and coaxially fixedly disposed in the housing 20. The inner rotor 50 has the form of a shaft and is coaxially fitted in the hole of the outer stator 40. The inner rotor 50 has a shaft body 51. The inner rotor 50 is bridged between the two end pieces 30 with two ends of the shaft body 51 respectively fitted in the bearings 33. The inner rotor 50 is rotatably supported by the end pieces 30 and the bearings 33. The two ends of the shaft body 51 respectively outward protrude from the end pieces 30 by a certain length for coupling with other components of the present invention.

The transmission member 60 has a circular body section 61. A shaft hole 62 is formed at a curvature center of the body section 61 and axially extends through the body section 61. A wall of the shaft hole 62 is recessed to form an elongated key slot 63, which extends along the axis of the body section 61. An elongated key 64 is disposed on a circumference of one end of the shaft body 51 and protrudes therefrom. The elongated key 64 is complementary to the elongated key slot 63.

Accordingly, the end of the shaft body 51 can be coaxially fitted in the shaft hole 62 of the transmission member 61 with the elongated key 64 complementarily inserted in the elongated key slot 63. Under such circumstance, the body section 61 is coaxially fixedly connected with the end of the shaft body 51 and synchronously rotatable therewith. A transmission section 65 is annularly disposed on a circumference of the body section 61. In this embodiment, the transmission section 65 is disposed on the circumference of the body section 61 in the form of a pair of annular grooves.

The brake member 70 and the sensing read head 80 are positioned at the other end of the shaft body 51. The brake member 70 serves to provide brake effect for the rotational motion of the shaft body 51. The sensing read head 80 serves to read the data of the rotational motion of the shaft body 51. In fact, the brake member 70 and the sensing read head 80 pertain to prior art and are not included in the scope of the present invention. Therefore, the techniques of the brake member 70 and the sensing read head 80 will not be further described hereinafter.

According to the above arrangement, the transmission member 60 is directly driven by the direct-drive motor module 10 to drive external transmission member such as the steel cable of an elevator. The steel cable of the elevator cabin can be wound and hung on the transmission section 65, whereby the elevator can be ascended/descended via the transmission member 60 in a direct-drive manner. In comparison with the prior art, the direct-drive motor module 10 of the present invention has the following advantages:
1. The load is driven by the direct-drive motor module 10 in a direct-drive manner to eliminate the problem of poor positioning precision that exists in the prior art due to backlash of the gears.
2. The direct-drive motor module 10 is free from the reducing mechanism so that the number of the components of the direct-drive motor module 10 is less than that of the prior art and the structure of the direct-drive motor module 10 is simplified. Therefore, as a whole, the volume of the direct-drive motor module 10 is minified and the service of the direct-drive motor module 10 is facilitated.
3. The end pieces 30 of the direct-drive motor module 10 serve to provide better support effect for the shaft body 51 by larger span. Moreover, the direct-drive motor module 10 can be fixed directly by means of the end pieces 30. Accordingly, the direct-drive motor module 10 can be more easily and quickly installed.

It should be noted that in the above embodiment, the transmission section 65 is, but not limited to, a pair of annular grooves. In practice, the structure of the transmission member is variable in accordance with the requirements of the actual load. For example, the transmission member can be alternatively a sprocket. Also, the application of the direct-drive motor module 10 of the present invention is not limited to the elevator. In practice, the direct-drive motor module 10 of the present invention is applicable to many other fields without any specific limitation.

The above embodiments are only used to illustrate the present invention, not intended to limit the scope thereof. Many modifications of the above embodiments can be made without departing from the spirit of the present invention.

What is claimed is:

1. A direct-drive motor module comprising:
a housing having two open ends;
two end pieces respectively fixedly disposed on end faces of the open ends of the housing, each end piece having a protruding side, the protruding sides of the end pieces protruding from the same side of the housing by a predetermined length;
a ring-shaped outer stator fixedly disposed in the housing;
a shaft-shaped inner rotor coaxially rotatably fitted in the outer stator, the inner rotor having a shaft body bridged between the two end pieces, at least one axial end of the shaft body outward protruding from the end piece;
a transmission member having a circular body section coaxially fixedly connected with an axial end of the shaft body, whereby the shaft body can drive the transmission member to synchronously rotate with the shaft body, a transmission section being annularly disposed on a circumference of the body section;
a brake member for providing brake effect for rotational motion of the inner rotor; and
a sensing read head for sensing data of the rotational motion of the inner rotor.

2. The direct-drive motor module as claimed in claim 1, wherein each end piece has a plate-shaped end section, an end face of the end section being fixedly attached to the end face of the open end of the housing, the end sections being arranged in parallel to each other.

3. The direct-drive motor module as claimed in claim 2, wherein each end piece has a bearing through hole formed on the end section, the bearing through hole being coaxial with the shaft body, a bearing being coaxially fixedly disposed in the bearing through hole and coaxially serially connected with the shaft body.

4. The direct-drive motor module as claimed in claim 1, wherein the edges of the protruding sides of the end pieces are straight and positioned on the same plane.

5. The direct-drive motor module as claimed in claim 1, wherein the transmission member has a shaft hole formed at a curvature center of the body section and axially extending through the body section, the end of the shaft body being fitted in the shaft hole of the transmission member to couple the body section with the shaft body.

6. The direct-drive motor module as claimed in claim 5, wherein the transmission member further has an elongated key slot formed on a wall of the shaft hole and extending extends along the axis of the body section, an elongated key being axially disposed on a circumference of the shaft body and complementary to the elongated key slot, the body section being fixedly connected with the shaft body with the elongated key complementarily inserted in the elongated key slot, whereby the body section is synchronously rotatable with the shaft body.

7. The direct-drive motor module as claimed in claim 6, wherein the wall of the shaft hole is recessed to form the elongated key slot, while the elongated key is disposed on the circumference of the shaft body and protrudes therefrom.
